(19) United States
(12) Patent Application Publication
(10) Pub. No.: US 2026/0191193 A1
(43) Pub. Date: Jul. 9, 2026

(54) FUNGICIDE COMPOSITION

(71) Applicants: UPL MAURITIUS LIMITED, Port Louis (MU); UPL EUROPE LTD, Warrington Cheshire (GB)

(72) Inventors: Charles Flood, Worcestershire (GB); Pardeep KAUR, Worcestershire (GB)

(21) Appl. No.: 18/868,577

(22) PCT Filed: May 24, 2023
(86) PCT No.: PCT/GB2023/051358

§ 371 Date: Nov. 22, 2024

(30) Foreign Application Priority Data
May 25, 2022 (GB) 2207660.8

(51) Int. Cl. A01N 37/26; A01P 3/00

(52) U.S. Cl. CPC A01N 37/26; A01P 3/00

(57) ABSTRACT

The present disclosure relates to a fungicide composition. More particularly, the present disclosure relates to a liquid fungicide composition comprising a benzamide fungicide and a combination of surfactants. The present disclosure also relates to a process for preparing the fungicide composition and a method for controlling growth of fungal phytopathogens using the same.

### TECHNICAL FIELD

The present disclosure relates to an agrochemical composition for application in crop protection. The present disclosure further relates to a process for the preparation of the said composition.

### BACKGROUND OF THE DISCLOSURE

Crop protection agrochemical compositions can be formulated in different ways, the properties of the active ingredients and the nature of the formulation possibly posing problems in terms of the ease of preparation, stability, ease of application, and activity of the formulations. Moreover, for reasons of economics and ecology, certain formulations are more advantageous than others.

There is a need for highly concentrated formulations of active ingredients since such formulations are associated with numerous advantages. For example, the cost and complexity of packaging required for high-concentration formulations is less than for low-concentration formulations. There is a resultant reduction in the cost and complexity of production, transport, storage, and additionally the operations of preparing the spray liquids that are used in agriculture, are simplified because of the handling of low-volume containers of crop protection compositions, such as during the operations of dispensing and stir-mixing.

Liquid formulations have an advantage over powder formulations that upon the reconstitution of a spray liquid, typically by adding water, they do not produce dust. Suspension concentrates are preferred liquid formulations, as they are concentrated. A suspension concentrate is defined as a suspension of solid particulate active ingredients in a liquid intended for dilution with water before use. Suspension concentrates have been developed mainly due to their several benefits when compared to other formulations, such as no dust formation, reduced toxicity and flammability due to solvents, better efficiency due to the smaller particle size and low packaging volume. However, issues relating to the formulation of suspension concentrates persist in terms of low surface tension, foaming and low pH, and the like. An acidic or low pH of the suspension concentrate adversely affects the soil when applied to crops and damages the appearance of the crops, therefore affecting the yield of the agricultural produce. A lower pH also can have an effect on the half-life of the active ingredients in the formulation causing its degradation.

Zoxamide is a benzamide fungicide, which is highly effective against oomycete pathogens. This fungicide disrupts the microtubule cytoskeleton by binding to β-tubulin. Presently, this fungicide is widely used on potatoes, vine crops, and other vegetable crops.

There is, however, a need in the art to develop a stable formulation of zoxamide that overcomes the drawbacks of the known formulations and yet has superior efficacy. There is a further need in the art to provide for a suspension concentrate formulation of zoxamide having a neutral pH and low surface tension, which confers stability.

### OBJECTIVES OF THE DISCLOSURE

It is a primary objective of the present disclosure to provide a stable liquid fungicide composition comprising a benzamide fungicide.

It is another objective of the present disclosure to provide a stable liquid composition having efficient retention of the active ingredients and improved suspensibility.

It is yet another objective of the present disclosure to provide a stable liquid composition having efficient phytopathogenic antifungal activity.

It is a further objective of the present disclosure to provide a stable suspension concentrate composition with absence of foam formation, high pH and better visual appearance of the formulation.

### SUMMARY OF THE DISCLOSURE

The present disclosure provides a fungicide composition comprising a benzamide fungicide and a combination of surfactants comprising an anionic surfactant and a non-ionic surfactant.

The present disclosure provides a suspension concentrate (SC) composition comprising zoxamide and a combination of surfactants comprising an anionic surfactant and a non-ionic surfactant.

In an aspect, the present disclosure provides a suspension concentrate composition comprising zoxamide and a combination of surfactants comprising an anionic surfactant and a non-ionic surfactant, wherein a weight ratio of the anionic surfactant to the non-ionic surfactant is ranging from about 20:1 to about 1:20.

In an aspect, the present disclosure provides a suspension concentrate composition comprising zoxamide and a combination of surfactants comprising an anionic surfactant and a non-ionic surfactant, wherein a weight ratio of the anionic surfactant to the non-ionic surfactant is ranging from about 15:1 to about 1:15.

In another aspect, the present disclosure provides use of the fungicide composition for controlling phytopathogenic fungi.

In one aspect, the present disclosure provides a method of controlling phytopathogenic fungi, the method comprising contacting a plant, parts of the plant, plant propagation material, pests, their food supply, habitat or breeding grounds with the suspension concentrate composition comprising zoxamide and a combination of surfactants comprising an anionic surfactant and a non-ionic surfactant.

In another aspect, the present disclosure provides a method of increasing the yield of the crop, the method comprising applying the fungicide composition of the present disclosure to the crop, or to plant propagation material or to the surface of agricultural produce.

In another aspect, the present disclosure provides a kit comprising a plurality of components, each of which components may include at least one, or more, of the ingredients of the fungicide composition of the present disclosure.

Additional features and advantages of the present disclosure will be apparent from the detailed description that follows, which illustrates by way of example, the most preferred features of the present disclosure which are not to be construed as limiting the scope of the disclosure described herein.

### DETAILED DESCRIPTION OF THE DISCLOSURE

The following description is provided to assist in a comprehensive understanding of exemplary embodiments of the disclosure. It includes various specific details to assist in that understanding but these are to be regarded as merely exemplary. Accordingly, those of ordinary skill in the art will recognize that various changes and modifications of the embodiments described herein can be made without departing from the scope of the disclosure. In addition, descriptions of well-known functions and constructions are omitted for clarity and conciseness.

The terms used in the following description and claims are not limited to the bibliographical meanings but are merely used by the inventor to enable a clear and consistent understanding of the disclosure. Accordingly, it should be apparent to those skilled in the art that the following description of exemplary embodiments of the present disclosure are provided for illustration purpose only and not for limiting the scope of the disclosure as defined by the appended claims and their equivalents.

For the purposes of the present disclosure, it is to be understood that the disclosure may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present disclosure in detail, it is to be understood that this disclosure is not limited to particularly exemplified systems or process parameters that may of course, vary. It is also to be understood that the terminology used herein is for the purpose of describing embodiments of the disclosure only and is not intended to limit the scope of the disclosure in any manner. The use of examples anywhere in this specification including examples of any terms discussed herein is illustrative only, and in no way limits the scope and meaning of the disclosure or of any exemplified term.

Prior to setting forth the present subject matter in detail, it may be helpful to provide definitions of certain terms used herein. Unless defined otherwise, all technical and scientific terms used herein have the same meaning as is commonly understood by one of skill in the art to which this subject matter pertains. The following definitions are provided for clarity.

The use of the terms “a”, “an”, and “the” and similar referents (especially in the context of the claims) are to be construed to cover both the singular and the plural, unless otherwise indicated herein or clearly contradicted by context. The terms first, second etc. as used herein are not meant to denote any ordering, but simply for convenience to denote a plurality of, for example, layers.

The terms “comprising”, “having”, “including”, and “containing” are to be construed as open-ended terms (i.e., meaning “including, but not limited to”) unless otherwise noted.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or =5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

As used herein, the term “agrochemical” is understood to denote an agricultural chemical such as pesticides, fungicides, insecticides, acaricides, herbicides, nematicides, plant growth regulators and can be used interchangeably.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the “propagation material thereof”, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop susceptible to or likely to be susceptible to infestation by fungi, and in which control of the fungi is desired. The locus includes the vicinity of desired crop plants wherein fungal infestation has either occurred or is most likely to occur or is yet to occur.

The salts referred to herein are agriculturally acceptable salts. As used herein, an “agriculturally acceptable salt” or “agrochemically acceptable salt” means a salt which is known and accepted for use in agricultural or horticultural use.

The term “agriculturally acceptable amount of active” refers to an amount of an active that kills or inhibits the pest/fungi on which control is desired, in an amount not significantly toxic to the plant being treated. The common names of active ingredients as mentioned in this specification are known from the “handbook of pesticides” 13th edition, British crop protection commission (2003) and also available at www.alanwood.net/pesticides.

As used herein, the term “stable” refers to chemical and/or physical stabilization of an active compound (e.g., fungicide) over a time interval. The stability tests described herein are conducted according to the Collaborative International Pesticides Analytical Council (CIPAC) methodologies.

By the term “active” as used herein, is meant an ingredient that is chemically active and/or biologically active in origin. By the term “active ingredient” as used herein, is meant zoxamide or a salt, or ester thereof. In this regard an “active” ingredient can be a single ingredient or a combination of ingredients; and the meaning of the term “active” shall be understood to include but not be limited to a “benzamide fungicide” or zoxamide or a salt, or ester thereof.

Particle size is typically defined as a log-normal distribution with a median diameter or D₅₀—that is 50% of the particles measured are less than the median value and 50% are greater than the median value. The term “particle size distribution” as used herein refers to the relative percentages by weight or volume of each of the different size fractions of a particulate matter. The term “median particle size”, “median diameter of particles”, “D₅₀”, as used herein refers to the median or 50% quantile of a particle size distribution. The term “D₅₀” hence defines a size where 50 volume percent of the particles have sizes less than the value given.

The term “D₉₀” hence defines a size where 90 volume percent of the particles have sizes less than the value given.

“Fungicide” refers to the ability of a substance to decrease or inhibit growth of fungi or oomycetes.

To “control” or “controlling” fungus means to inhibit, and/or suppress the ability of fungus to grow and/or reproduce, or to limit fungus-related damage or loss in crop plants or denotes control and prevention of a disease. Controlling effects include all deviation from natural development, for example: killing, retardation, decrease of the fungal disease.

As described herein, “fungicidally effective amount” is an amount of active ingredient such as a fungicide which causes an adversely modifying effect and includes deviations from natural development, killing, regulation, desiccation, retardation, and the like.

According to the present disclosure, “increased yield” of an agricultural plant means that the yield of a product of the respective plant is increased by a measurable amount over the yield of the same product of the plant produced under the same conditions, but without the application of the present disclosure.

As used herein, the term “pre-mix” refers to a formulation of more than one component in a ready-mix formulation and intended to be applied onto plants with/without further dilution with water to make a mixture.

As used herein, the term “g a.i./ha” as used herein denotes the concentration of the respective active ingredient in “grams” applied “per hectare” of the crop field.

Each of the aspects described above may have one or more embodiments. Each of the embodiments described hereinafter may apply to one or all aspects described hereinabove. These embodiments are intended to be read as being preferred features of one or all aspects described hereinabove. Each of the embodiments described hereinafter applies to each of the aspects described hereinabove individually.

The inventors of the present disclosure have found the stability of zoxamide in a fungicide composition, specifically a suspension concentrate formulation in terms of the absence of foam formation, high pH with better visual appearance of the formulation using the combination of an anionic surfactant and non-ionic surfactant to be exemplary.

In an embodiment, the present disclosure provides an agrochemical composition.

Accordingly in an embodiment, the present disclosure provides a fungicide composition.

Accordingly, the present disclosure provides a fungicide composition comprising a benzamide fungicide.

In an embodiment, the benzamide fungicide is selected from the group comprising benzohydroxamic acid, flumetover, fluopicolide, fluopimomide, tioxymid, trichlamide, zarilamid, zoxamide, salts, isomers, or combinations thereof.

In a preferred embodiment, the benzamide fungicide is zoxamide.

In an embodiment, benzamide fungicides are also known as tubulin polymerization fungicides.

In a preferred embodiment, zoxamide is also known as a tubulin polymerization fungicide.

Accordingly, the present disclosure provides a fungicide composition comprising zoxamide and at least one surfactant.

In an embodiment, the fungicide composition comprises zoxamide and at least one surfactant comprising an anionic surfactant and a non-ionic surfactant.

In an embodiment, the present disclosure provides a fungicide composition comprising zoxamide and at least two surfactants.

In an embodiment, the fungicide composition comprises zoxamide and at least two surfactants comprising an anionic surfactant and a non-ionic surfactant.

In an embodiment, the present disclosure provides a fungicide composition comprising zoxamide and a combination of surfactants.

In an embodiment, the fungicide composition comprises zoxamide and a combination of surfactants comprising an anionic surfactant and a non-ionic surfactant.

In an embodiment, the present disclosure provides a fungicide composition comprising zoxamide and a blend of surfactants.

In an embodiment, the fungicide composition comprises zoxamide and a blend of surfactants comprising an anionic surfactant and a non-ionic surfactant.

Accordingly, the present disclosure provides a fungicide composition comprising a benzamide fungicide, namely zoxamide, and a combination of surfactants, comprising an anionic surfactant and a non-ionic surfactant, for use in controlling phytopathogenic fungi and oomycetes.

According to an embodiment of the present disclosure, the fungicide composition comprises from about 1% w/w to about 80% w/w benzamide fungicide of total weight of the composition.

In an embodiment of the present disclosure, the fungicide composition comprises from about 1% w/w to about 60% w/w benzamide fungicide of total weight of the composition.

In an embodiment of the present disclosure, the fungicide composition comprises from about 10% w/w to about 50% w/w benzamide fungicide of total weight of the composition.

In an embodiment of the present disclosure, the fungicide composition comprises from about 10% w/w to about 40% w/w benzamide fungicide of total weight of the composition.

In a preferred embodiment, the fungicide composition comprises from about 10% w/w to about 30% w/w zoxamide of total weight of the composition.

In a preferred embodiment, the fungicide composition comprises about 22.5% w/w zoxamide of total weight of the composition.

In a preferred embodiment, the fungicide composition comprises zoxamide in a concentration range from about 240 g/L to about 250 g/L.

According to an embodiment, the surfactant is selected from the group comprising an anionic surfactant, a non-ionic surfactant, or combinations thereof.

In an embodiment, the surfactant comprises an anionic surfactant and a non-ionic surfactant.

In an embodiment, the anionic surfactant is a sulfonic acid surfactant.

In an embodiment, the sulfonic acid surfactant is selected from the group comprising substituted and polymeric alkyl and aryl sulfonates such as sodium alkylnaphthalene sulfonate, sodium naphthalene sulfonate, calcium lignosulphonate, sodium lignosulphonate, sodium polynaphthalene sulfonate, ammonium lignosulphonate, or combinations thereof.

In another embodiment, the anionic surfactant is a sulfonic acid surfactant selected from the group comprising sodium alkylnaphthalene sulfonate, sodium naphthalene sulfonate, calcium lignosulphonate, sodium lignosulphonate, sodium polynaphthalene sulfonate, and ammonium lignosulphonate, or combinations thereof.

In a preferred embodiment, the sulfonic acid surfactant is sodium lignosulphonate.

In a preferred embodiment, the anionic surfactant is sodium lignosulphonate.

In an embodiment, the non-ionic surfactant is an ethoxylated alcohol.

In an embodiment, the non-ionic surfactant is an ethoxylated alcohol selected from the group comprising alkylamine ethoxylates, acrylate graft copolymer ethoxylates, block polymers, carboxylated alcohol or alkylphenol ethoxylates, alcohol ethoxylates, ethoxylated alkylphenols, glycol esters, polyethylene glycols, silicone-based surfactants, tristyrylphenol ethoxylates, ethoxylated isotridecyl alcohol, or combinations thereof.

In an embodiment, the non-ionic surfactant is an ethoxylate selected from the group comprising alkylamine ethoxylates, alkylphenol ethoxylates, alcohol ethoxylates, tristyrylphenol ethoxylates, or combinations thereof.

In a preferred embodiment, the non-ionic surfactant is ethoxylated isotridecyl alcohol.

In an embodiment, the surfactant is selected from one or more sulfonic acid surfactants and an ethoxylated alcohol.

In an embodiment, at least one surfactant is selected from a sulfonic acid surfactant and an ethoxylated alcohol.

In an embodiment, at least two surfactants are selected from a sulfonic acid surfactant and an ethoxylated alcohol.

In an embodiment, a combination of surfactants are selected from a sulfonic acid surfactant and an ethoxylated alcohol.

In an embodiment, a blend of surfactants are selected from a sulfonic acid surfactant and an ethoxylated alcohol.

In an embodiment, the fungicide composition comprises from about 1% w/w to about 40% w/w combination of surfactants of total weight of the composition.

In an embodiment, the fungicide composition comprises from about 1% w/w to about 20% w/w combination of surfactants of total weight of the composition.

In an embodiment, the fungicide composition comprises from about 1% w/w to about 15% w/w combination of surfactants of total weight of the composition.

In a preferred embodiment, the fungicide composition comprises about 10.07% w/w combination of surfactants of total weight of the composition.

In an embodiment, the fungicide composition comprises from about 1% w/w to about 30% w/w anionic surfactant of total weight of the composition.

In an embodiment, the fungicide composition comprises from about 1% w/w to about 30% w/w sulfonic acid surfactant of total weight of the composition.

In an embodiment, the fungicide composition comprises from about 1% w/w to about 15% w/w sulfonic acid surfactant of total weight of the composition.

In a preferred embodiment, the fungicide composition comprises about 8.95% w/w sodium lignosulphonate of total weight of the composition.

In a preferred embodiment, the fungicide composition comprises sodium lignosulphonate in a concentration range from about 75 g/L to about 130 g/L.

In an embodiment, the fungicide composition comprises from about 0.5% w/w to about 20% w/w non-ionic surfactant of total weight of the composition.

In an embodiment, the fungicide composition comprises from about 0.5% w/w to about 20% w/w ethoxylated alcohol surfactant of total weight of the composition.

In an embodiment, the fungicide composition comprises from about 1% w/w to about 10% w/w ethoxylated alcohol surfactant of total weight of the composition.

In a preferred embodiment, the fungicide composition comprises about 1.12% w/w ethoxylated isotridecyl alcohol of total weight of the composition.

In a preferred embodiment, the fungicide composition comprises ethoxylated isotridecyl alcohol in a concentration range from about 7.5 g/L to about 15 g/L.

In a preferred embodiment, the composition comprises from about 1% w/w to about 30% w/w anionic surfactant, and from about 0.5% w/w to about 20% w/w non-ionic surfactant of total weight of the composition.

In an embodiment, the present disclosure provides a fungicide composition comprising:
(a) a benzamide fungicide; and
(b) at least one surfactant comprising an anionic surfactant and a non-ionic surfactant;
wherein a weight ratio of the anionic surfactant to the non-ionic surfactant ranges from about 20:1 to about 1:20.

In an embodiment, the present disclosure provides a fungicide composition comprising:
(a) a benzamide fungicide; and
(b) at least two surfactants comprising an anionic surfactant and a non-ionic surfactant;
wherein a weight ratio of the anionic surfactant to the non-ionic surfactant ranges from about 20:1 to about 1:20.

In an embodiment, the present disclosure provides a fungicide composition comprising:
(a) a benzamide fungicide; and
(b) a combination of surfactants comprising an anionic surfactant and a non-ionic surfactant;
wherein a weight ratio of the anionic surfactant to the non-ionic surfactant ranges from about 20:1 to about 1:20.

In an embodiment, the present disclosure provides a fungicide composition comprising:
(a) a benzamide fungicide; and
(b) a blend of surfactants comprising an anionic surfactant and a non-ionic surfactant;
wherein a weight ratio of the anionic surfactant to the non-ionic surfactant ranges from about 20:1 to about 1:20.

In another embodiment, the weight ratio of the anionic surfactant to the non-ionic surfactant is selected from ratios comprising 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 and 1:20.

In a preferred embodiment, the present disclosure provides a fungicide composition comprising:
(a) zoxamide; and
(b) a combination of surfactants comprising a sulphonic acid surfactant and an ethoxylated alcohol;
wherein a weight ratio of the sulphonic acid surfactant to the ethoxylated alcohol ranges from about 15:1 to about 1:15.

In a preferred embodiment, the present disclosure provides a fungicide composition comprising:
(a) zoxamide; and
(b) a combination of surfactants comprising sodium lignosulphonate and ethoxylated isotridecyl alcohol;
wherein a weight ratio of sodium lignosulphonate to ethoxylated isotridecyl alcohol is about 8:1.

In a preferred embodiment, the present disclosure provides a fungicide composition comprising:
(a) zoxamide; and
(b) a combination of surfactants comprising sodium lignosulphonate and ethoxylated isotridecyl alcohol;
wherein a weight ratio of sodium lignosulphonate to ethoxylated isotridecyl alcohol is about 7.99:1.

In an embodiment, the compositions that can be used in the present disclosure include both solid and liquid-based compositions. The compositions of the present disclosure can be formulated in a manner which suits the specific application. The formulation may be solid or liquid formulations. Non-limiting examples of suitable liquid formulations may be emulsion concentrates (EC), suspension concentrates (SC), capsule suspensions (CS), oil dispersion (OD); and suitable solid formulations may be water dispersible granules (WDG) and wettable powders (WP), dusts and the like.

In a preferred embodiment, the fungicide composition is a liquid composition.

In an embodiment, the fungicide composition is a liquid formulation.

In an embodiment, the fungicide composition is a suspension concentrate (SC) formulation.

In an embodiment, the present disclosure provides a suspension concentrate fungicide composition comprising:
(a) a benzamide fungicide; and
(b) at least one surfactant comprising an anionic surfactant and a non-ionic surfactant.

In an embodiment, the present disclosure provides a suspension concentrate fungicide composition comprising:
(a) a benzamide fungicide; and
(b) at least two surfactants comprising an anionic surfactant and a non-ionic surfactant.

In an embodiment, the present disclosure provides a suspension concentrate fungicide composition comprising:
(a) a benzamide fungicide; and
(b) a combination of surfactants comprising an anionic surfactant and a non-ionic surfactant.

In an embodiment, the present disclosure provides a suspension concentrate fungicide composition comprising:
(a) a benzamide fungicide; and
(b) a blend of surfactants comprising an anionic surfactant and a non-ionic surfactant.

In an embodiment, the present disclosure provides a suspension concentrate fungicide composition comprising:
(a) a benzamide fungicide; and
(b) at least one surfactant comprising an anionic surfactant and a non-ionic surfactant;
wherein a weight ratio of the anionic surfactant to the non-ionic surfactant ranges from about 20:1 to about 1:20.

In an embodiment, the present disclosure provides a suspension concentrate fungicide composition comprising:
(a) a benzamide fungicide; and
(b) at least two surfactants comprising an anionic surfactant and a non-ionic surfactant;
wherein a weight ratio of the anionic surfactant to the non-ionic surfactant ranges from about 20:1 to about 1:20.

In an embodiment, the present disclosure provides a suspension concentrate fungicide composition comprising:
(a) a benzamide fungicide; and
(b) a combination of surfactants comprising an anionic surfactant and a non-ionic surfactant;
wherein a weight ratio of the anionic surfactant to the non-ionic surfactant ranges from about 20:1 to about 1:20.

In an embodiment, the present disclosure provides a suspension concentrate fungicide composition comprising:
(a) a benzamide fungicide; and
(b) a blend of surfactants comprising an anionic surfactant and a non-ionic surfactant;
wherein a weight ratio of the anionic surfactant to the non-ionic surfactant ranges from about 20:1 to about 1:20.

In an embodiment, the present disclosure provides a suspension concentrate fungicide composition comprising:
(a) zoxamide; and
(b) a combination of surfactants comprising an anionic surfactant and a non-ionic surfactant;
wherein a weight ratio of the anionic surfactant to the non-ionic surfactant ranges from about 20:1 to about 1:20.

In a preferred embodiment, the present disclosure provides a suspension concentrate fungicide composition comprising:
(a) zoxamide; and
(b) a combination of surfactants comprising an anionic surfactant and a non-ionic surfactant;
wherein a weight ratio of the anionic surfactant to the non-ionic surfactant ranges from about 15:1 to about 1:15.

In an embodiment, the present disclosure provides a suspension concentrate fungicide composition comprising:
(a) zoxamide; and
(b) a combination of surfactants comprising a sulphonic acid surfactant and an ethoxylated alcohol;
wherein a weight ratio of the sulphonic acid surfactant to the ethoxylated alcohol ranges from about 20:1 to about 1:20.

In a preferred embodiment, the present disclosure provides a suspension concentrate (SC) fungicide composition comprising:
(a) zoxamide; and
(b) a combination of surfactants comprising a sulphonic acid surfactant and an ethoxylated alcohol;
wherein a weight ratio of the sulphonic acid surfactant to the ethoxylated alcohol ranges from about 15:1 to about 1:15.

In a preferred embodiment, the present disclosure provides a suspension concentrate composition comprising:
(a) zoxamide; and
(b) a combination of surfactants comprising sodium lignosulphonate and ethoxylated isotridecyl alcohol;
wherein a weight ratio of sodium lignosulphonate to ethoxylated isotridecyl alcohol ranges from about 10:1 to about 1:10.

In a preferred embodiment, the present disclosure provides a suspension concentrate fungicide composition comprising:
(a) zoxamide; and
(b) a combination of surfactants comprising sodium lignosulphonate and ethoxylated isotridecyl alcohol;
wherein a weight ratio of sodium lignosulphonate to ethoxylated isotridecyl alcohol is about 8:1.

In a preferred embodiment, the present disclosure provides a suspension concentrate fungicide composition comprising:
(a) zoxamide; and
(b) a combination of surfactants comprising sodium lignosulphonate and ethoxylated isotridecyl alcohol;
wherein a weight ratio of sodium lignosulphonate to ethoxylated isotridecyl alcohol is about 7.99:1.

In an embodiment, the active ingredient in the suspension concentrate fungicide composition has a particle size distribution D₅₀ of less than about 10 microns.

In an embodiment, the active ingredient in the suspension concentrate fungicide composition has a particle size distribution D₅₀ of less than about 5 microns.

In an embodiment, the active ingredient in the suspension concentrate fungicide composition has a particle size distribution D₉₀ of less than about 20 microns.

In an embodiment, the active ingredient in the suspension concentrate fungicide composition has a particle size distribution D₉₀ of less than about 10 microns.

In an embodiment, the fungicide composition discloses a superior suspensibility, better dispersibility, better homogeneity and no sedimentation. In an embodiment the present suspension concentrate fungicide composition is stable for up to 4 months at room temperature.

In an embodiment the present disclosure provides a suspension concentrate fungicide composition comprising:
(a) zoxamide;
(b) a combination of surfactants comprising an anionic surfactant and a non-ionic surfactant; and
(c) at least one agrochemically acceptable excipient.

In a preferred embodiment, the present disclosure provides a suspension concentrate composition comprising:
(a) zoxamide;
(b) a combination of surfactants comprising sodium lignosulphonate and ethoxylated isotridecyl alcohol; and
(c) at least one agrochemically acceptable excipient;
wherein a weight ratio of sodium lignosulphonate to ethoxylated isotridecyl alcohol ranges from about 10:1 to about 1:10.

In an embodiment the present disclosure provides a suspension concentrate fungicide composition comprising:
(a) about 10% to about 40% w/w zoxamide;
(b) about 1% to about 20% w/w combination of surfactants comprising an anionic surfactant and a non-ionic surfactant; and
(c) at least one agrochemically acceptable excipient.

In an embodiment, the agrochemically acceptable excipient is selected from the group comprising wetting agent(s), dispersing agent(s), binding agent(s), anti-freeze agent(s), surfactant(s), preservative(s), mineral(s), coloring agent(s), pH adjusting agent(s), antifoaming agent(s), solvent(s), or combinations thereof. However, it should be appreciated that any other agrochemically acceptable excipient, as known to a person skilled in the art, may be used to serve its intended purpose.

In an embodiment, the agrochemically acceptable excipients are present in an amount ranging from about 1% to about 99% w/w of total weight of the composition.

In an embodiment, the agrochemically acceptable excipients are present in an amount ranging from about 1% to about 60% w/w of total weight of the composition.

In an embodiment, the agrochemically acceptable excipients are present in an amount ranging from about 1% to about 30% w/w of total weight of the composition.

According to an embodiment, the wetting agent(s) may include any or a combination of sulfosuccinates, naphthalene sulfonates, olyoxypr esters, phosphate esters, olyoxypr alcohol and alkyl benzene sulfonates, but not limited thereto.

In an embodiment, the dispersing agent(s) may include any or a combination comprising polycarboxylates, naphthalene sulfonate condensates, phenol sulfonic acid condensates, lignosulphonates, methyl oleyl taurates and polyvinyl alcohols, but not limited thereto.

In another embodiment, the binding agent(s) may include any or a combination comprising polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

In an embodiment, the surfactant(s) which may be included are selected from sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated 24olyoxypropylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

In an embodiment, the anti-freezing agents may include any or a combination of ethylene glycol, propylene glycol, urea, glycerin and anti-freeze proteins, but not limited thereto. In an embodiment, the anti-freeze compound is a glycol selected from ethylene glycol, diethylene glycol, triethylene glycol, propylene glycol, mono propylene glycol, dipropylene glycol, tripropylene glycol, glycerol, and mixtures thereof.

In a preferred embodiment, the anti-freeze compound is propylene glycol.

In a preferred embodiment, the anti-freeze compound is mono propylene glycol.

In an embodiment, the mineral(s) may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

In an embodiment, the coloring agent(s) may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum, zinc, or combinations thereof.

In an embodiment, suitable antifoaming agents for purposes of the present disclosure include but are not limited to silicone-based defoamers, for example; acetylene-based defoamers, and perfluoroalkylphosphinic acid and phosphonic acids and their salts. Preferred defoamers are those from the group of linear polydimethylsiloxanes having an average dynamic viscosity, measured at about 25° C., in the range from about 1000 to about 800 millipascal-second (mPa·s), usually about 1200 to about 6000 mPa·s, and containing silica. Silica includes polysilicic acids, meta-silicic acid, ortho-silicic acid, silica gel, silicic acid gels, kieselguhr, precipitated SiO₂, and the like. Defoamers from the group of linear polydimethylsiloxanes contain as their chemical backbone a compound of the formula HO—[Si(CH₃)₂—O—]ₙH, in which the end groups are modified, by etherification for example, or are attached to the groups —Si(CH₃)₃. Particularly preferred are polydimethylsiloxane, wherein two methyl groups are attached to each silicon atom to form (H₃C)[SiO(CH₃)₂]ₙSi(CH₃) and simethicone, which is a mixture of polydimethylsiloxane and silica.

In an embodiment, the present composition further comprises at least one buffering agent acting as a pH adjusting agent(s) to maintain the pH of the composition.

According to an embodiment, examples of suitable solvent(s) are water, oils of vegetable, or derivatives. In principle, solvent mixtures may also be used.

According to an embodiment, the present disclosure provides a suspension concentrate fungicide composition comprising:
(a) a benzamide fungicide;
(b) a combination of surfactants comprising an anionic surfactant and a non-ionic surfactant; wherein a weight ratio of the anionic surfactant to the non-ionic surfactant ranges from about 20:1 to about 1:20; and
(c) optionally at least one agrochemically acceptable excipient.

In an embodiment, the fungicide composition further comprises an anti-freeze agent.

In a preferred embodiment, the anti-freeze agent is mono propylene glycol.

In a preferred embodiment, the fungicide composition comprises mono propylene glycol in a concentration range from about 70 g/L to about 90 g/L.

In an embodiment, the fungicide composition further comprises an antifoam agent. In a preferred embodiment, the antifoam agent is emulsion of polyorganosiloxanes.

In a preferred embodiment, the fungicide composition comprises emulsion of polyorganosiloxanes in a concentration range from about 5 g/L to about 15 g/L.

In an embodiment, the fungicide composition further comprises a thickener agent.

In a preferred embodiment, the thickener agent is xanthan gum.

In a preferred embodiment, the fungicide composition comprises xanthan gum in a concentration range from about 1 g/L to about 5 g/L.

In an embodiment, the fungicide composition further comprises a preservative.

In a preferred embodiment, the preservative is 1,2-Benzisothiazolin-3-one.

In a preferred embodiment, the fungicide composition comprises 1,2-Benzisothiazolin-3-one in a concentration range from about 0.5 g/L to about 3 g/L.

In an embodiment, the fungicide composition further comprises a solvent.

In a preferred embodiment, the solvent is water.

In an embodiment, the present disclosure provides a fungicide composition consisting of:
(a) a benzamide fungicide;
(b) a combination of surfactants comprising an anionic surfactant and a non-ionic surfactant; wherein a weight ratio of the anionic surfactant to the non-ionic surfactant ranges from about 20:1 to about 1:20; and
(c) optionally at least one agrochemically acceptable excipient.

In an embodiment, the present disclosure provides a fungicide composition consisting of:
(a) a benzamide fungicide;
(b) a combination of surfactants comprising an anionic surfactant and a non-ionic surfactant; wherein a weight ratio of the anionic surfactant to the non-ionic surfactant ranges from about 20:1 to about 1:20; and
(c) at least one agrochemically acceptable excipient.

According to an embodiment, the present disclosure provides a fungicide composition consisting of:
(a) a benzamide fungicide;
(b) a combination of surfactants comprising an anionic surfactant and a non-ionic surfactant; wherein a weight ratio of the anionic surfactant to the non-ionic surfactant ranges from about 20:1 to about 1:20;
(c) an anti-freeze agent;
(d) an antifoam agent;
(e) a thickener agent;
(f) a preservative; and
(g) a solvent.

In a preferred embodiment, the present disclosure provides a fungicide composition consisting of:
(a) zoxamide;
(b) a combination of sodium lignosulphonate and ethoxylated isotridecyl alcohol; wherein a weight ratio of sodium lignosulphonate to ethoxylated isotridecyl alcohol is 20:1 to about 1:20; and
(c) water.

In an embodiment, the suspension concentrate fungicide composition may be present in an aqueous form.

In an embodiment, the aqueous suspension concentrate may further comprise a thickening agent and/or a biocidal compound.

In an embodiment, the suitable thickening agent is a hydroxyethyl cellulose, a gelling and thickening agent derived from cellulose. Especially preferred is hydroxyethylcellulose surface-treated with glyoxal.

Suitable preservatives are typical biocidal compounds, an example being 1,2-Benzisothiazolin-3-one and a mixture of 1,2-benzoisothiazol-3 (2H)-one and 2-methyl-2H-isothiazol-3-one, biocide.

In a preferred embodiment of the disclosure, the suspension concentrate further comprises a thickening agent and a biocidal compound in a concentration of up to about 1% w/w of total weight of the composition.

In a preferred embodiment, the present disclosure provides a suspension concentrate composition comprising:
(a) zoxamide; and
(b) a combination of surfactants comprising sodium lignosulphonate and ethoxylated isotridecyl alcohol;
wherein the composition further comprises:
(c) mono propylene glycol as an anti-freeze agent;
(d) emulsion of polyorganosiloxanes as an antifoaming agent;
(e) xanthan gum as a thickening agent; and
(f) 1,2-Benzisothiazolin-3-one as a preservative.

In a preferred embodiment, the present disclosure provides a suspension concentrate (SC) fungicide composition comprising:
(c) zoxamide;
(d) a combination of surfactants comprising sodium lignosulphonate and ethoxylated isotridecyl alcohol; and
(e) at least one agrochemically acceptable excipient;
wherein a weight ratio of sodium lignosulphonate to ethoxylated isotridecyl alcohol ranges from about 10:1 to about 1:10.

In an embodiment, the present disclosure provides a suspension concentrate fungicide composition comprising:
(a) about 10% to about 40% w/w zoxamide;
(b) about 1% to about 20% w/w combination of surfactants comprising an anionic surfactant and a non-ionic surfactant; and
(c) about 1% to about 30% w/w agrochemically acceptable excipient.

In an embodiment, the present disclosure provides a suspension concentrate fungicide composition comprising:
(a) a benzamide fungicide; and
(b) a combination of surfactants comprising an anionic surfactant and a non-ionic surfactant;
wherein the fungicide composition is in a form of a tank mix or a pre-formulated (pre-mix)/ready-mix formulation.

According to an embodiment, the present disclosure provides a fungicide composition in a form of a pre-formulated (pre-mix) formulation.

In an embodiment, the present disclosure provides a pre-mix suspension concentrate fungicide composition comprising:
(a) a benzamide fungicide; and
(b) a combination of surfactants comprising an anionic surfactant and a non-ionic surfactant.

Accordingly in an embodiment, the fungicide composition disclosed herein may be applied together as a pre-mix formulation.

In yet another embodiment, the fungicide compositions may be applied to the soil prior to emergence of the seedling (pre-emergence), to prevent establishment of the fungi. Alternatively, the application of the fungicide composition may be post the emergence of the seedling (post-emergence) to prevent growth of the fungal phytopathogens.

In yet another embodiment, the fungicide composition may be applied as a foliar spray at different timings during crop development, with as many early applications (pre-emergence) or late (post-emergence) applications as required.

In an embodiment, the present disclosure provides process for preparation of the present fungicide composition, particularly liquid fungicide composition, more particularly suspension concentrate fungicide composition.

According to an embodiment, the process for preparing a fungicide composition comprises:
(a) adding a benzamide fungicide and a combination of surfactants to form a mixture;
(b) subjecting the mixture to stirring and milling; and
(c) adding at least one agrochemically acceptable excipient to the mixture of step (b) in water and homogenizing the mixture to obtain the fungicide composition.

In another embodiment, the process for preparation of the present fungicide composition comprises:
(a) adding zoxamide, sodium lignosulphonate and ethoxylated isotridecyl alcohol in a charging vessel to form a mixture;
(b) subjecting the mixture to high shear stirring and milling; and
(c) adding suitable agrochemically acceptable excipients to the mixture of step (b) in water and homogenizing the mixture by stirring to obtain the fungicide composition.

In another embodiment, the present disclosure provides the process for preparation of suspension concentrate fungicide composition comprising:
(a) adding zoxamide, sodium lignosulphonate and ethoxylated isotridecyl alcohol in a charging vessel to form a mixture;
(b) subjecting the mixture to high shear stirring and milling it to a particle size D₅₀ of less than about 5 microns; and
(c) adding agrochemically acceptable excipients to the mixture of step (b) in water and homogenizing the mixture by stirring to obtain the fungicide composition.

According to an embodiment, the present disclosure provides use of a fungicide composition, for controlling growth of fungal phytopathogens.

According to an embodiment, the present disclosure provides use of a fungicide composition comprising a benzamide fungicide and a combination of surfactants comprising an anionic surfactant and a non-ionic surfactant, for controlling growth of fungal phytopathogens;
wherein a weight ratio of the anionic surfactant to the non-ionic surfactant ranges from about 20:1 to about 1:20.

In an embodiment, the present disclosure provides use of the fungicide composition comprising zoxamide and a combination of surfactants including an anionic surfactant and a non-ionic surfactant, for controlling phytopathogenic fungi and oomycetes.

In an embodiment, the present disclosure provides use of the fungicide composition comprising zoxamide and a combination of surfactants including a sulphonic acid surfactant and an ethoxylated alcohol, for controlling phytopathogenic fungi and oomycetes.

In an embodiment, the present disclosure provides use of a suspension concentrate fungicide composition comprising zoxamide and a combination of surfactants including a sulphonic acid surfactant and an ethoxylated alcohol, for controlling phytopathogenic fungi and oomycetes.

In another aspect the present disclosure provides use of a suspension concentrate fungicide composition comprising zoxamide and a combination of surfactants including a sulphonic acid surfactant and an ethoxylated alcohol, for increasing yield of the crops.

Accordingly, the fungicide composition of the present disclosure is found to be highly active against a wide variety of phytopathogenic fungi in crops.

In an embodiment, the crops can be selected from but not limited to cereals, such as wheat, oats, barley, spelt, triticale, rye, maize, millet, rice, crops such as sugarcane, soybean, sunflower, rape, canola, tobacco, sugar beet, fodder beet; tuber crops such as potatoes, sweet potatoes etc., crops such as asparagus, hops etc., fruit plants such as apples, pears, stone-fruits such as for example peaches, nectarines, cherries, plums, apricots, citrus fruits such as oranges, grapefruit, limes, lemons, kumquats, mandarins, satsumas; nuts such as pistachios, almonds, walnuts, pecan nuts, tropical fruits such as mango, papaya, pineapple, dates, bananas etc., grapes, vegetables such as endives, lambs, lettuce, fennel, globe and loose-leaf salad, chard, spinach, chicory, cauliflower, broccoli, Chinese cabbage, kale (winter kale or curly kale), kohlrabi, Brussel sprouts, red cabbage, white cabbage and savoy, fruiting vegetables such as aubergines, cucumbers, paprika, marrow, tomatoes, courgettes, sweetcorn, root vegetables such as celeriac, turnip, carrots, swedes, radishes, horse radish, beetroot, salsify, celery, pulses such as peas, beans etc., bulb vegetables such as leeks, onions etc., oil crops such as mustard, poppy, olives, sunflowers, coconut, castor oil plants, cocoa beans, groundnuts; fibre crops such as cotton, jute, flex, hemp, crops such as tea, coffee, rubber, ornamentals including shrubs and flowering plants, vines, rangeland and pastures.

According to another embodiment, the fungicide composition may be applied before or after infection of the plants by the fungal phytopathogens, to the plant, or a locus or a plant propagation material thereof.

In another embodiment, the fungicide composition may be used for foliar application, application to a ground, or to a plant, or a locus or a plant propagation material, or combinations thereof.

According to an embodiment, the present disclosure provides a method for controlling growth of fungal phytopathogens, the method comprising: applying to a plant, or a locus, or a plant propagation material thereof, an effective amount of a fungicide composition comprising a benzamide fungicide and a combination of surfactants comprising an anionic surfactant and a non-ionic surfactant; wherein a weight ratio of the anionic surfactant to the non-ionic surfactant ranges from about 20:1 to about 1:20.

In an embodiment, the present disclosure provides a method of controlling phytopathogenic fungi, the method comprising applying a fungicide composition to a locus where fungal control is desired, said suspension concentrate fungicide composition comprising zoxamide and a combination of surfactants comprising an anionic surfactant and a non-ionic surfactant, wherein a weight ratio of the anionic surfactant to the non-ionic surfactant is ranging from about 20:1 to about 1:20.

In an embodiment, the present disclosure provides a method of controlling phytopathogenic fungi, the method comprising applying to a locus where fungal control is desired, a suspension concentrate fungicide composition comprising zoxamide and a combination of surfactants comprising sodium lignosulphonate and ethoxylated isotridecyl alcohol, wherein the weight ratio of sodium lignosulphonate to ethoxylated isotridecyl alcohol is ranging from about 20:1 to about 1:20.

In a preferred embodiment, the present disclosure provides a method of controlling phytopathogenic fungi, the method comprising applying to a locus where fungal control is desired, a suspension concentrate fungicide composition comprising zoxamide and a combination of surfactants comprising sodium lignosulphonate and ethoxylated isotridecyl alcohol, wherein the weight ratio of sodium lignosulphonate and ethoxylated isotridecyl alcohol is ranging from about 15:1 to about 1:15.

In an embodiment, the fungicide composition can be used to control fungal diseases, for example pea diseases caused by one or more species of: Alternaria alternata, Aphanomyces euteiches f. sp. pisi, Ascochyta pinodella, Ascochyta pinodes, Ascochyta pisi, Botryotinia fuckeliana, Botrytis cinerea, Cercospora pisa-sativae, Chalara elegans, Cladosporium cladosporioides f. sp. pisicoia, Cladosporium pisicoia, Colletotrichum gloeosporioides, Colletotrichum pisi, Erysiphe pisi, Fusarium oxysporum, Fusarium oxysporum. sp. pisi, Fusarium solani, Fusicladium pisicoia, Glomerella cingulata, Mycosphaerella pinodes, Oidium sp., Peronospora viciae, Phoma pinodella, Pythium spp., Rhizoctonia solani, Sclerotinia sclerotiorum, Septoria pisi, Thanatephonis cucumeris, Thielaviopsis hasicola and Uromyces fabae, Soybean diseases: Cercospora kikuchii, Elsinoe glycines, Diaporthe phaseolorum var. sojae, Septoria glycines, Cercospora sojina, Phakopsora pachyrhizi, Phytophthora sojae Rhizoctonia solani.

The method of the present disclosure may be used to control a broad spectrum of plant diseases, such as:
Disease in rice: Blast (Magnaporthe grisea), Helminthosporium leaf spot (Cochliobolus miyabeanus), sheath blight (Rhizoctonia solani), and bakanae disease (Gibberella fujikuroi).
Diseases in wheat: powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).
Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).
Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).
Diseases of citrus: melanose (Diaporthe citri), scab (Elsinoe fawcetti), penicillium rot (Penicillium digitatum, P. italicum), and brown rot (Phytophthora parasitica, Phytophthora citrophthora).
Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophthora cactorum), blotch (Diplocarpon mali), and ring rot (Botryosphaeria berengeriana).
Diseases of pear: scab (Venturia nashicola, V. pirina), powdery mildew, black spot (Alternaria alternata Japanese pear pathotype), rust (Gymnosporangium haraeanum), and phytophthora fruit rot (Phytophthora cactorum).
Diseases of peach: brown rot (Monilinia fructicola), powdery mildew, scab (Cladosporium carpophilum), and phomopsis rot (Phomopsis sp.).
Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).
Diseases of Japanese persimmon: anthracnose (Gloeosporium kaki), and leaf spot (Cercospora kaki, Mycosphaerella nawae).
Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).
Diseases of tomato: early blight (Alternaria solani), leaf mold (Cladosporium fulvum), and late blight (Phytophthora infestans).
Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).
Diseases of onion: rust (Puccinia allii), and downy mildew (Peronospora destructor).
Diseases of soybean: purple seed stain (Cercospora kikuchii), sphaceloma scad (Elsinoe glycines), pod and stem blight (Diaporthe phaseolorum var. sojae), septoria brown spot (Septoria glycines), frog eye leaf spot (Cercospora sojina), rust (Phakopsora pachyrhizi), Yellow rust, brown stem rot (Phytophthora sojae), and Rhizoctonia damping-off (Rhizoctonia solani).
Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).
Diseases of garden pea: powdery mildew (Erysiphe pisi), and root rot (Fusarium solani f. sp. pisi).
Diseases of potato: early blight (Alternaria solani), late blight (Phytophthora infestans), pink rot (Phytophthora erythroseptica), and powdery scab (Spongospora subterranean f. sp. subterranea).
Diseases of strawberry: powdery mildew (Sphaerotheca humuli), and anthracnose (Glomerella cingulata).
Diseases of tea: net blister blight (Exobasidium reticulatum), white scab (Elsinoe leucospila), gray blight (Pestalotiopsis sp.), and anthracnose (Colletotrichum theae-sinensis).
Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).
Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).
Diseases of sugar beet: Cercospora leaf spot (Cercospora beticola), leaf blight (Thanatephorus cucumeris), Root rot (Thanatephorus cucumeris), and Aphanomyces root rot (Aphanomyces cochlioides).
Diseases of rose: black spot (Diplocarpon rosae), powdery mildew (Sphaerotheca pannosa), and downy mildew (Peronospora sparsa), Diseases of chrysanthemum and asteraceous plants: downy mildew (Bremia lactucae), leaf blight (Septoria chrysanthemi-indici), and white rust (Puccinia horiana).
Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).
Disease of Japanese radish: Alternaria leaf spot (Alternaria brassicicola).
Diseases of turfgrass: dollar spot (Sclerotinia homeocarpa), and brown patch and large patch (Rhizoctonia solani).
Disease of banana: Black sigatoka (Mycosphaerella fijiensis), Yellow sigatoka (Mycosphaerella musicola).
Disease of sunflower: downy mildew (Plasmopara halstedii).
Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp, and Diplodia spp.
Viral diseases of various plants mediated by Polymxa spp, or Olpidium spp. and so on.

The disclosure also provides a method for the protection of plant propagation material, preferably seeds, and the seedlings' roots and shoots from phytopathogenic fungi, the method comprising contacting the plant propagation material, e.g., the seeds before sowing and/or after pre-germination with compositions of the present disclosure.

According to an embodiment, the present disclosure provides a method for controlling growth of fungal phytopathogens, wherein the fungicide composition is applied in a range from about 10 g a.i./ha to about 5000 g a.i./ha.

In an embodiment, the present disclosure provides a method for controlling growth of fungal phytopathogens, wherein the fungicide composition is applied in a range from about 10 g a.i./ha to about 3000 g a.i./ha.

In an embodiment, the present disclosure provides a method for controlling growth of fungal phytopathogens, wherein the fungicide composition is applied in a range from about 10 g a.i./ha to about 1500 g a.i./ha.

In an embodiment, the present disclosure provides a method for controlling growth of fungal phytopathogens, wherein the fungicide composition is applied in a range from about 10 g a.i./ha to about 500 g a.i./ha.

In an embodiment, the present disclosure provides a method for controlling growth of fungal phytopathogens, wherein the fungicide composition is applied in a range from about 50 g a.i./ha to about 450 g a.i./ha.

According to an embodiment, the various components of the suspension concentrate fungicide composition are used individually or already partially or completely mixed with one another to prepare the suspension concentrate fungicide composition. It is also possible for the component to be separately packaged and used as a component in a kit of parts.

In one embodiment, the kits may include one or more of the components that are used to prepare a suspension concentrate fungicide composition. For examples, the kits may include active ingredients and/or a combination of surfactants. One or more of the components may already be combined together or pre-formulated.

According to an embodiment of the present disclosure, a kit comprising a stable agrochemical composition is provided. The kit comprises a plurality of components, including at least one of the ingredients of the stable fungicide composition of the present disclosure.

In one embodiment of the present disclosure, the kit includes at least one, or all of components needed to prepare the stable fungicide composition. For example, the kit may include zoxamide, an anionic surfactant and a non-ionic surfactant.

One or more of the components may already be combined or pre-formulated. In those embodiments where more than two components are provided in a kit, the components may already be combined and as such are packaged in a single container such as a vial, bottle, can, pouch, bag and/or canister. In other embodiments, two or more components of a kit may be packaged separately, i.e., not pre-formulated. As such, a kit may include one or more separate containers such as vials, cans, bottles, pouches, bags and/or canisters, each container containing a separate component for stable fungicide composition.

In both forms, a component of the kit may be applied separately from or together with the further components or as a component of a combination or composition according to the disclosure for preparing the stable fungicide composition according to the disclosure.

The disclosure also provides a kit comprising fungicide composition for the controlling the growth of fungal phytopathogens and instructions for use. The instructions for use typically comprise instructions for the application of the fungicide composition to a plant, or a locus, or a plant propagation material thereof.

According to an embodiment, the kit of parts comprises:
(a) a benzamide fungicide; and
(b) a combination of surfactants comprising an anionic surfactant and a non-ionic surfactant;
and optionally further comprises:
(c) instructions for use.

In another embodiment, the kit of parts comprises:
(a) zoxamide; and
(b) a combination of surfactants comprising a sulphonic acid surfactant and an ethoxylated alcohol;
and optionally further comprises:
(c) instructions for use.

In a preferred embodiment, the kit of parts comprises:
(a) zoxamide; and
(b) a combination of surfactants comprising sodium lignosulphonate and ethoxylated isotridecyl alcohol;
and optionally further comprises:
(c) instructions for use.

The composition described above is fungicidally efficacious and is stable. It has been found that the surfactant mixture of the suspension concentrate fungicide composition of the present disclosure provides excellent stability over time and at various temperatures, and even when the said suspension concentrate fungicide composition undergoes shear forces for example on mixing. Also, the stable fungicide composition obtained by the process have superior suspensibility, better dispersibility, very low or no sedimentation and little particle degradation.

All the features described herein may be combined with any of the above aspects, in any combination. In order that the present disclosure may be more readily understood, reference will now be made, by way of example, to the following description. However, the scope of the present disclosure is not limited by the examples in any manner. It will be appreciated by any person skilled in this art that the present disclosure includes aforesaid examples and further can be modified and altered within the scope of the present disclosure.

It will be understood that all tests and physical properties listed have been determined at atmospheric pressure and room temperature (i.e., 25° C.), unless otherwise stated herein, or unless otherwise stated in the referenced test methods and procedures.

It will be understood that the specification and examples are illustrative but not limitative of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

The disclosure will be illustrated with reference to the following examples:

### Example 1: Zoxamide Suspension Concentrate (SC) Composition

| Ingredients | Amount (w/w) % |
|---|---|
| Zoxamide | 22.15 |
| Ethoxylated isotridecyl alcohol | 1.12 |
| Mono propylene glycol | 7.16 |
| Sodium lignosulphonate | 8.95 |
| Polydimethylsiloxane oil | 0.90 |
| Water | Q.S. |
| Total | 100 |

### Process:

The process for preparation of the suspension concentrate fungicide composition comprises ingredients in respective quantities as mentioned in the table above. Water was added to a vessel under stirring followed by adding polydimethylsiloxane oil. Ethoxylated isotridecyl alcohol was warmed between a temperature from about 25° C. to about 30° C. and then homogenized before use. Mono propylene glycol and sodium lignosulphonate were charged into the vessel and subsequently zoxamide was added. The said mixture was homogenized during addition of the active ingredient by stirring and was passed over a colloid mill. The agitator in the loading tank was turned to slow speed and agitation was continued during the grinding process to prevent settling. The slurry was milled using a horizontal bead mill and the processing conditions were adjusted such that the temperature of the milled slurry does not exceed a temperature of about 40° C. The complete mill base was transferred into a hold tank. A gel was added to the hold tank under constant stirring until complete homogeneity was achieved.

### Example 2: Physico-Chemical Stability Data

The stability of zoxamide SC composition prepared as per Example 1 was evaluated at accelerated heat stability (AHS) conditions (2 weeks for 54° C.) and at 3 months for 40° C. for its physical parameters.

TABLE 2
Physical properties of composition of Example 1

| | | | | 3 |
|---|---|---|---|---|
| | | Initial | 2 weeks | months |
| General properties | Units | observations | 54° C. | 40° C. |
| Content of Zoxamide | g/kg | 216 | 214 | 215 |
| Content of Zoxamide | g/L | 241 | 239 | 241 |
| Suspensibility Zoxamide (0.2%) | % | 99 | 99 | 99 |
| 20° C. | | | | |
| Suspensibility Zoxamide | % | 99 | 99 | 99 |
| (0.375%) 20° C. | | | | |
| Dispersibility Zoxamide | % | 86 | 91 | 90 |
| (0.375%) 20° C. | | | | |
| Density | g/mL | 1.118 | 1.118 | 1.120 |
| pH neat | | 6.68 | 6.75 | 6.63 |
| pH (1% in HPLC water) | | 7.23 | 6.78 | 7.05 |
| Particle size: D₅₀ | μm | 1.93 | 1.98 | 1.98 |
| D₉₀ | μm | 6.43 | 6.58 | 6.60 |
| Sieve test: 75 μm | % | <0.01 | <0.01 | <0.01 |
| 45 μm | | <0.01 | <0.01 | <0.01 |

Appearance

| | | | | |
|---|---|---|---|---|
| Syneresis | % | 0 | 2 | 2 |
| Sediment (Y/N/Sticky) | | N | N | N |
| Homogenize (Easy/Hard/Stir) | | Easy | Easy | Easy |
| Appearance after homogenization | | Normal | Normal | Normal |

Dispersion stability in water A

| | | | |
|---|---|---|---|
| Appearance after 30 minutes | H | H | H |
| (F/H/S) | | | |
| Appearance after 24 hours | S, <1 ml | S, <1 ml | S, <1 ml |
| (F/H/S) | | | |
| Re-dispersibility after 24 hours | 23 | 27 | 21 |
| Appearance after 24.5 hours | H | H | H |

Dispersion stability in water D

| | | | |
|---|---|---|---|
| Appearance after 30 minutes | H | H | H |
| (F/H/S) | | | |
| Appearance after 24 hours | S, <1 ml | S, <1ml | S, <1 ml |
| (F/H/S) | | | |
| Re-dispersibility after 24 hours | 9 | 23 | 10 |
| Appearance after 24.5 hours | H | H | H |

Sediment:
Y = normal sediment
N = no sediment or not detectable
Water hardness
Water D: 342 ppm
Water A: 20 ppm
Dispersion stability:
H = Homogenous
Appearance:
H = homogenous
S = sediment (ml)
F = flocculation

The stability of the composition was evaluated at 2 weeks at 54° C. and at 3 months at 40° C. and compared with the initial observations of the composition.

It was found that the active content remained almost constant without any significant deterioration or loss. The composition also passed wet sieve testing as no crystals were observed to be retained on wet sieve. Particle size of composition was analysed and found to be nearly constant suggesting negligible particle size growth or crystal formation (Table 2). The pH was also maintained to be high over the tested time periods. The composition of Example 1 showed improved suspensibility, improved homogeneity, and no sedimentation. Therefore, it was concluded that the composition of Example 1 remained stable in ambient as well as AHS which assured overall stability of the composition.

### Example 3: Surfactant Screening and Comparative Study

The different anionic and non-ionic surfactants were tested alone and in various combinations before arriving at a robust combination of surfactants that contribute to a stable suspension concentrate composition. After deriving the optimal weight of the active ingredient to the combination of surfactants, various anionic and non-ionic surfactants were tested to evaluate its effect on the finalized composition.

The compositions for the purpose of comparing physical stability were developed by keeping the active ingredients of the present composition constant and combining various surfactants within the optimal ratio, these comparative examples were designated as ‘A’, ‘B’ and ‘C’. The stability was tested at 2 weeks at 54° C.

The present disclosure provides the rationale behind the selection of the surfactants used in the fungicide compositions.

TABLE 3
Surfactant screening

| | Present | | | |
|---|---|---|---|---|
| Surfactants (g/L) | composition | A | B | C |
| Sodium lignosulphonate | 100 | — | 10 | — |
| Ethoxylated isotridecyl | 12.5 | 100 | 100 | — |
| alcohol | | | | |
| Calcium lignosulphonate | — | 10 | — | — |
| Polymeric surfactant | — | — | — | 30 |
| Block co-polymer | — | — | — | 30 |

Observed parameters

| | | | | |
|---|---|---|---|---|
| pH | 8.4 | 4.85 | 4.93 | N.T. |
| Surface tension | 33.4 | 36.1 | 34.8 | 47.9 |
| Foam formation after 1 | No foam | N.T. | N.T. | 20 |
| minute | | | | millimeter |
| | | | | (mm) - |
| | | | | (too much |
| | | | | foam) |

N.T.: not tested

The present composition as described above discloses a high pH and a low surface tension which is favourable for application in crops.

### Example 4: Stability Study

The stability of zoxamide SC composition prepared as per Example 1 was evaluated for 6 and 12 months at 0° C. and 25° C., for its physical parameters.

TABLE 4
Physical properties of composition of Example 1

| | | 6 months | | 12 months | |
|---|---|---|---|---|---|
| | Initial | Temperature | | | |
| General properties | observations | 0° C. | 25° C. | 0° C. | 25° C. |
| Syneresis (%) | 0 | 0 | 0 | 0 | 0 |
| Sediment | N | N | N | N | N |
| (Y/N/Sticky) | | | | | |
| pH neat | 6.8 | 6.5 | 6.5 | 7.1 | 6.9 |

Particle size (μm)

| D₅₀ | 1.7 | 1.7 | 1.8 | 1.7 | 1.8 |
|---|---|---|---|---|---|
| D₉₀ | 5.5 | 5.5 | 5.7 | 5.5 | 5.7 |
| Microscopic | Well | Fair | | Fair | Good |
| appearance | dispersed. | dispersion, | | dispersion, | dispersion, |
| | Crystals | majority <10 | | majority <5-10, | majority <5 |
| | under 10 μm | up to 20 | | larger | up to 15 |
| | with the odd | | | aggregates | |
| | one around | | | up to 17 | |
| | 15 μm | | | | |
| Appearance after 30 | 0 | <0.05 | 0 | <0.05 | 0 |
| minutes | | | | | |
| Appearance after 1 | 0 | <0.05 | 0 | <0.05 | 0 |
| hour | | | | | |
| Appearance after 4 | 0 | <0.05 | 0 | <0.05 | 0 |
| hours | | | | | |

Sediment:
Y = normal sediment
N = no sediment or not detectable

The stability of the composition was evaluated at 6 and 12 months at 0° C. and 25° C. and compared with the initial observations of the composition. Particle size of composition was analysed and found to be nearly constant suggesting little to negligible particle size growth or crystal formation. The pH was also maintained to be high over the tested time periods. The composition of Example 1 showed no sedimentation. Therefore, it was concluded that the composition of Example 1 remained stable at 6 months to 12 months, which assured overall stability of the composition.

### Example 5: Zoxamide Suspension Concentrate (SC) Composition

| Ingredients | Concentration (g/L) |
|---|---|
| Zoxamide | 240-250 |
| Ethoxylated isotridecyl alcohol | 7.5-15 |
| Mono propylene glycol | 70-90 |
| Sodium lignosulphonate | 75-130 |
| Water | Q.S. |
| Total | 100 |

### Process:

The process of preparation of the composition of Example 5 is the same as disclosed in Example 1.

Therefore, inventors of the present disclosure found that the suspension concentrate composition developed according to the present disclosure using the selected anionic surfactant and non-ionic surfactant resulted into a stable composition. The selected surfactants provided improved performance over time, with low or no sedimentation, and little particle size degradation. The suspension concentrate composition prepared according to the present disclosure also passed wet sieve tests indicating product stability.

What is claimed is:

1. A fungicide composition comprising:
(a) a benzamide fungicide; and
(b) a combination of surfactants comprising an anionic surfactant and a non-ionic surfactant;
wherein a weight ratio of the anionic surfactant to the non-ionic surfactant ranges from about 20:1 to about 1:20.

2. The composition as claimed in claim 1, wherein the benzamide fungicide is selected from the group consisting of benzohydroxamic acid, flumetover, fluopicolide, fluopimomide, tioxymid, trichlamide, zarilamid, zoxamide, salts, isomers, and combinations thereof.

3. The composition as claimed in claim 2, wherein the benzamide fungicide is zoxamide.

4. The composition as claimed in claim 1, wherein the anionic surfactant is a sulfonic acid surfactant selected from the group consisting of sodium alkylnaphthalene sulfonate, sodium naphthalene sulfonate, calcium lignosulphonate, sodium lignosulphonate, sodium polynaphthalene sulfonate, and ammonium lignosulphonate, and combinations thereof.

5. The composition as claimed in claim 4, wherein the anionic surfactant is sodium lignosulphonate.

6. The composition as claimed in claim 1, wherein the non-ionic surfactant is an ethoxylated alcohol selected from the group consisting of alkylamine ethoxylates, acrylate graft copolymer ethoxylates, block polymers, carboxylated alcohol or alkylphenol ethoxylates, alcohol ethoxylates, ethoxylated alkylphenols, glycol esters, polyethylene glycols, silicone-based surfactants, and tristyrylphenol ethoxylates, ethoxylated isotridecyl alcohol, and combinations thereof.

7. The composition as claimed in claim 6, wherein the non-ionic surfactant is ethoxylated isotridecyl alcohol.

8. The composition as claimed in claim 1, wherein the composition comprises from about 10% w/w to about 50% w/w benzamide fungicide of total weight of the composition.

9. The composition as claimed in claim 1, wherein the composition comprises from about 1% w/w to about 40% w/w combination of surfactants of total weight of the composition.

10. The composition as claimed in claim 1, wherein the composition comprises from about 1% w/w to about 30% w/w anionic surfactant, and from about 0.5% w/w to about 20% w/w non-ionic surfactant of total weight of the composition.

11. A suspension concentrate composition comprising:
(a) zoxamide;
(b) a combination of surfactants comprising sodium lignosulphonate and ethoxylated isotridecyl alcohol; and
(c) at least one agrochemically acceptable excipient;
wherein a weight ratio of sodium lignosulphonate and ethoxylated isotridecyl alcohol ranges from about 10:1 to about 1:10.

12. The composition as claimed in claim 11, wherein the agrochemically acceptable excipient is selected from the group comprising wetting agent, dispersing agent, binding agent, anti-freeze agent, surfactant, preservative, mineral, coloring agent, pH adjusting agent, antifoaming agent, solvent, or combinations thereof.

13. (canceled)

14. A process for preparing a fungicide composition as claimed in claim 1, the process comprising:
(a) adding a benzamide fungicide and a combination of surfactants to form a mixture;
(b) subjecting the mixture to stirring and milling; and
(c) adding at least one agrochemically acceptable excipient to the mixture of step (b) in water and homogenizing the mixture to obtain the fungicide composition.

15. A method for controlling growth of fungal phytopathogens, the method comprising:
applying to a plant, or a locus, or a plant propagation material thereof, an effective amount of a fungicide composition comprising a benzamide fungicide and a combination of surfactants comprising an anionic surfactant and a non-ionic surfactant;
wherein a weight ratio of the anionic surfactant to the non-ionic surfactant ranges from about 20:1 to about 1:20.
